(19) United States
(12) Patent Application Publication
(10) Pub. No.: US 2009/0074501 A1
(43) Pub. Date: Mar. 19, 2009

(54) Hair dye application system

(76) Inventor: Eric D. Miller, Pueblo, CO (US)

Correspondence Address: WELSH & FLAXMAN LLC, 2000 DUKE STREET, SUITE 100, ALEXANDRIA, VA, 22314, US

(21) Appl. No.: 11/898,689

(22) Filed: Sep. 14, 2007

(51) Int. Cl. A46B 11/00; B43K 5/00

(52) U.S. Cl. 401/129; 401/118; 401/132

(57) ABSTRACT

A hair dye application system includes a package having a first rupturable cavity containing hair dye and a second rupturable cavity containing an activator. The package also includes a reservoir in fluid communication with the first rupturable cavity and the second rupturable cavity. When the first rupturable cavity and the second rupturable cavity are ruptured, the hair dye and the activator respectively held within the first rupturable cavity and the second rupturable cavity are forced out of the respective first rupturable cavity and second rupturable cavity and into the reservoir. A brush is housed within the package for selective removal therefrom.

### BACKGROUND OF THE INVENTION

1. Field of the Invention

The invention relates to a hair dye application system. More particularly, the invention relates to a self-contained, hair dye application system for easy touchups between trips to a salon.

2. Description of the Related Art

Numerous individuals dye their hair for a variety of reasons, from a desire to have a color other than their natural color to concealing gray hairs brought on by the onset of aging. There are currently wide assortments of methods and products available dyeing hair from home dye kits to professional salon treatments.

Approximately one week after the dyeing process, the original color begins to become visible in specific areas of the scalp. For men the original color begins to show around the temples and for females the original color begins to show along the hair part line. Correcting this problem can be complicated, expensive and require regularly scheduled touch-ups. Systems are known which utilize multiple bottles and bowls requiring large packaging and clean-up.

As a result, a need exists for a quick all-inclusive touch-up kit that allows an individual to quickly dye showing areas without the need to redye the entire hair. The present invention is designed to fit in any type of carrying case, from a suitcase to a purse. This self-contained compact nature allows for little wasted product and virtually no clean-up.

### SUMMARY OF THE INVENTION

It is, therefore, an object of the present invention to provide a hair dye application system including a package having a first rupturable cavity containing hair dye and a second rupturable cavity containing an activator. The package also includes a reservoir in fluid communication with the first rupturable cavity and the second rupturable cavity. When the first rupturable cavity and the second rupturable cavity are ruptured, the hair dye and the activator respectively held within the first rupturable cavity and the second rupturable cavity are forced out of the respective first rupturable cavity and second rupturable cavity and into the reservoir. A brush is housed within the package for selective removal therefrom.

It is also an object of the present invention to provide a hair dye application system wherein the brush includes a handle and a bristle head.

It is another object of the present invention to provide a hair dye application system wherein the bristle head is positioned within the reservoir for contact with the hair dye and the activator.

It is a further object of the present invention to provide a hair dye application system wherein the first rupturable cavity and the second rupturable cavity are part of an upper compartment of the package.

It is also another object of the present invention to provide a hair dye application system wherein the reservoir is part of a lower compartment of the package.

It is also a further object of the present invention to provide a hair dye application system wherein a first separating wall is positioned between the first rupturable cavity and the reservoir, and a second separating wall is positioned between the second rupturable cavity and the reservoir.

It is still a further object of the present invention to provide a hair dye application system wherein the package is plastic.

It is yet a further object of the present invention to provide a hair dye application system wherein surfaces of the first rupturable cavity and the second rupturable cavity are flexible and exposed for the selective application of pressure by a user to rupture the first rupturable cavity and the second rupturable cavity.

It is also an object of the present invention to provide a hair dye application system wherein the package includes a transverse slot extending along the length of the package and a handle of the brush extends within the transverse slot.

It is another object of the present invention to provide a hair dye application system including a cleaning wipe on a rear side of the package.

It is a further object of the present invention to provide a hair dye application system wherein a first end of the brush is positioned at a first end of the package for selective exposure from the first end of the package for gripping and withdrawal of the brush.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is the hair dye application system.

FIG. 2A is a front view of the hair dye application system.

FIG. 2B is a side view of the hair dye application system.

FIG. 2C is a back view of the hair dye application system.

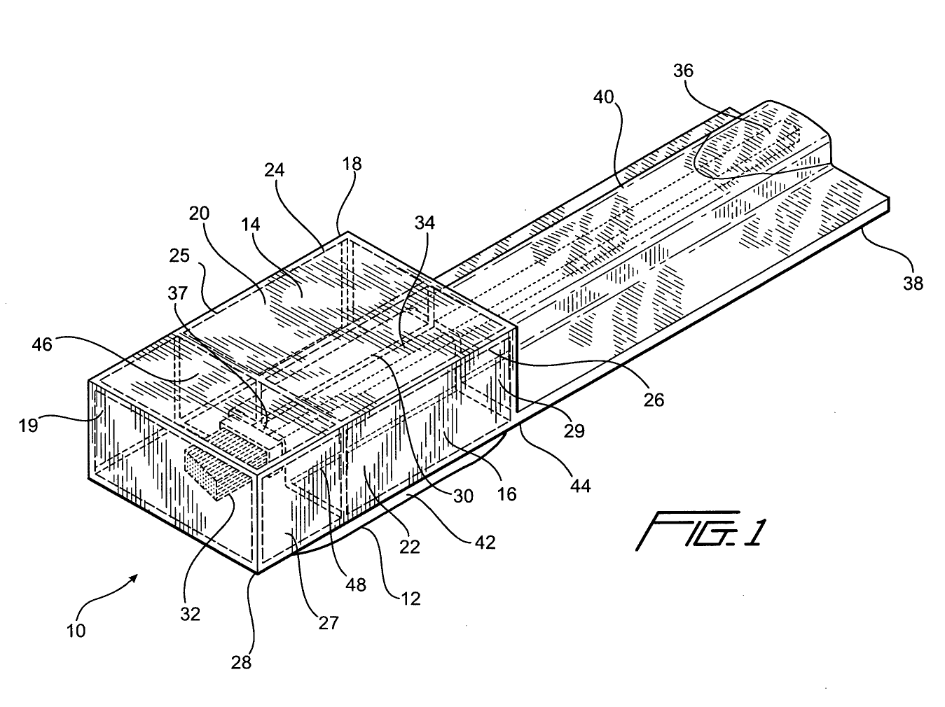

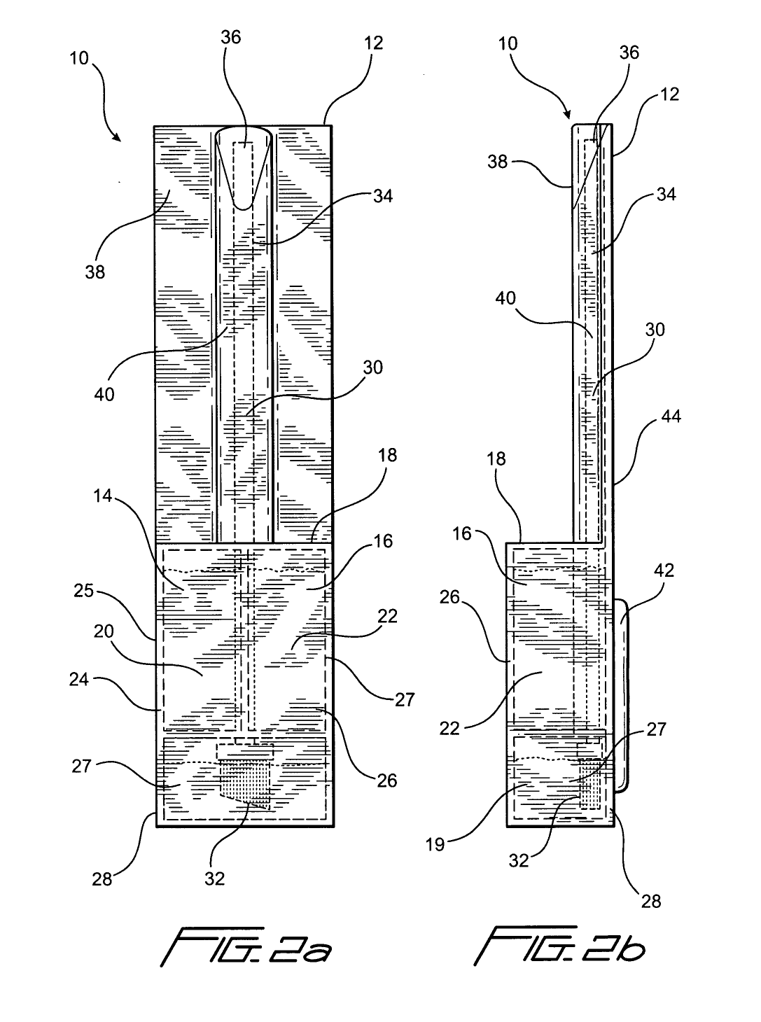

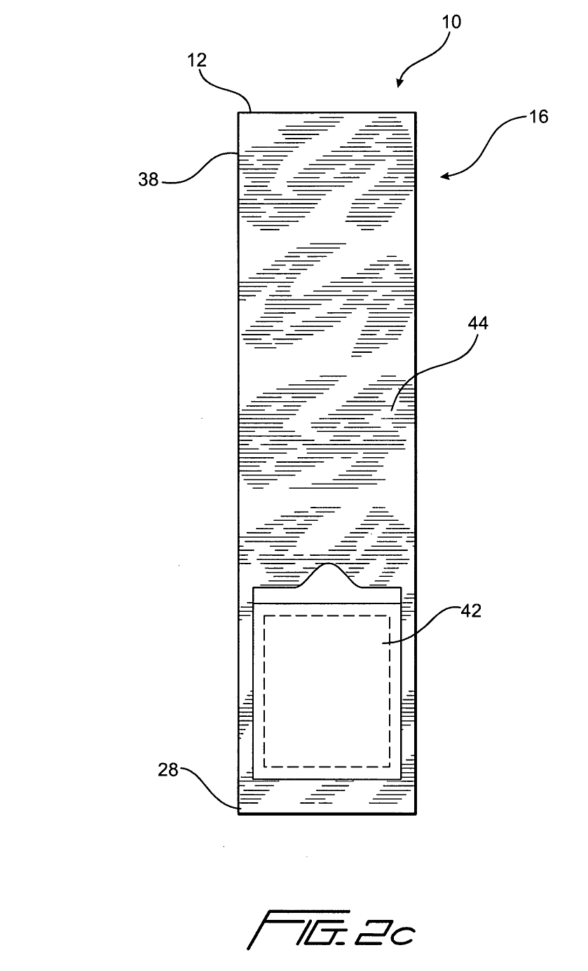

### DESCRIPTION OF THE PREFERRED EMBODIMENT

The detailed embodiment of the present invention is disclosed herein. It should be understood, however, that the disclosed embodiment is merely exemplary of the invention, which may be embodied in various forms. Therefore, the details disclosed herein are not to be interpreted as limiting, but merely as a basis for teaching one skilled in the art how to make and/or use the invention.

In accordance with the present invention and with reference to the various figures, a hair dye application system 10 is disclosed. The hair dye application system 10 includes a plastic package 12. The package 12 is divided into various compartments in fluid communication for permitting the flow of hair dye 14 and activator 16 in a manner discussed below in greater detail. More particularly, the package 12 includes an upper compartment 18 and a lower compartment 19. The upper compartment 18 is split into a first rupturable cavity 20 and a second rupturable cavity 22. The respective upper surfaces 24, 26 and side surfaces 25, 29 of the first rupturable cavity 20 and the second rupturable cavity 22 are flexible and exposed for the selective application of pressure by a user to rupture the first rupturable cavity 20 and the second rupturable cavity 22. When ruptured, the hair dye 14 and activator 16 respectively held within the first rupturable cavity 20 and the second rupturable cavity 22 are forced out of the respective first and second rupturable cavities 20, 22 and into a reservoir 27 formed in the lower compartment 19 at the second end 28 of the package 12. It is contemplated the rupturable cavities may be filled and pressurized to allow them to be ruptured by squeezing between the end user's fingers. As those skilled in the art will certainly appreciate, the amount of hair dye 14 and activator 16 placed within the reservoirs in determined by the specific hair dye and activator used in conjunction with the present invention, and this amount may certainly be varied without departing from the spirit of the present invention.

More particularly, the lower compartment 19 of the package 12 is provided with a reservoir 27 that is in fluid communication with the first rupturable cavity 20 and the second rupturable cavity 22. A first separating wall 46 is positioned between the first rupturable cavity 20 and the reservoir 27. The first separating wall 46 is designed to open upon the application of a preselected amount of pressure to the first rupturable cavity 20 permitting the flow of hair dye 14 into the reservoir 27. A second separating wall 48 is positioned between the second rupturable cavity 22 and the reservoir 27. The second separating wall 48 is designed to open upon the application of a preselected amount of pressure to the second rupturable cavity 22 permitting the flow of activator 16 into the reservoir 27 for mixing with the hair dye 14.

A brush 30 is housed within the package 12 for selective removal therefrom. The brush 30 includes a bristle head 32 with a handle 34 extending therefrom. The bristle head 32 of the brush 30 is positioned within the reservoir 27 for contact with the hair dye 14 and activator 16 forced thereon. The handle 34 includes a first end 36 and second end 37. The first end 36 of the handle 34 is positioned at the first end 38 of the package 12 for selective exposure from the first end 38 of the package 12 for gripping and withdrawal of the brush 30. The second end 37 of the handle 34 is coupled to the bristle head 32.

Storage of the brush 30 within the package 12 is achieved by providing the package 12 with a transverse slot 40 within which the handle 34 of the brush 30 is stored as it extends along the length of the package 12. The transverse slot 40 is wide enough that the bristle head 32 may be withdrawn from the package 12 for use. A cleaning wipe 42 is located on the rear side 44 of the plastic package 12 for use after and during the application of the hair dye 14.

In use, a user squeezes the first and second rupturable cavities 20, 22 containing the hair dye 14 and activator 16. The application of pressure to the respective upper surfaces 24, 26 and side surfaces 25, 29 of first rupturable cavity 20 and the second rupturable cavity 22 causes the first and second separating walls 46, 48 to break open. The hair dye 14 and activator 16 then flow into the reservoir 27 where they mix together. If required in accordance with the specific hair dye 14 and activator 16 used in accordance with the present invention, it may be necessary to shake the reservoir 27 to ensure the hair dye 14 and activator 16 our thoroughly mixed. The first end 38 of the plastic package 12 is then opened to expose and gain access to the first end 36 of the handle 34 of the brush 30. The plastic package 12 is thus open to create an open container into which the bristle head 32 of the brush 30 can be dipped into the reservoir 27 of the plastic package 12 to get the hair dye/activator mixture to apply to the hair roots. After the hair dye/activator mixture is applied to the root areas, the cleaning wipe 42 can be used to wipe any excess of the hair dye/activator mixture from the hair, face and/or fingers of the user. After the application of the hair dye/activator to the hair, it is left in the user's hair for a predetermined time. Thereafter, the hair dye/activator applied to the hair is washed out of the user's hair in accordance with the specific mixture used in accordance with the specific application of the present invention. Finally, the hair dye application system 10 is disposed of into a proper waste receptacle.

While the preferred embodiments have been shown and described, it will be understood that there is no intent to limit the invention by such disclosure, but rather, is intended to cover all modifications and alternate constructions falling within the spirit and scope of the invention.

1. A hair dye application system, comprising:
a package including a first rupturable cavity containing hair dye and a second rupturable cavity containing an activator, the package also includes a reservoir in fluid communication with the first rupturable cavity and the second rupturable cavity, wherein when the first rupturable cavity and the second rupturable cavity are ruptured, the hair dye and the activator respectively held within the first rupturable cavity and the second rupturable cavity are forced out of the respective first rupturable cavity and second rupturable cavity and into the reservoir;
a brush housed within the package for selective removal therefrom.

2. The hair dye application system according to claim 1, wherein the brush includes a handle and a bristle head.

3. The hair dye application system according to claim 2, wherein the bristle head is positioned within the reservoir for contact with the hair dye and the activator.

4. The hair dye application system according to claim 1, wherein the first rupturable cavity and the second rupturable cavity are part of an upper compartment of the package.

5. The hair dye application system according to claim 4, wherein the reservoir is part of a lower compartment of the package.

6. The hair dye application system according to claim 1, wherein a first separating wall is positioned between the first rupturable cavity and the reservoir, and a second separating wall is positioned between the second rupturable cavity and the reservoir.

7. The hair dye application system according to claim 1, wherein the package is plastic.

8. The hair dye application system according to claim 1, wherein surfaces of the first rupturable cavity and the second rupturable cavity are flexible and exposed for the selective application of pressure by a user to rupture the first rupturable cavity and the second rupturable cavity.

9. The hair dye application system according to claim 1, wherein the package includes a transverse slot extending along the length of the package and a handle of the brush extends within the transverse slot.

10. The hair dye application system according to claim 1, further including a cleaning wipe on a rear side of the package.

11. The hair dye application system according to claim 1, wherein a first end of the brush is positioned at a first end of the package for selective exposure from the first end of the package for gripping and withdrawal of the brush.
